(19) United States
(12) Patent Application Publication
(10) Pub. No.: US 2021/0032496 A1
(43) Pub. Date: Feb. 4, 2021

(54) COATING AGENT, ANTI-FOGGING FILM, METHOD FOR MANUFACTURING ANTI-FOGGING FILM, AND LAMINATE

(71) Applicant: FUJIFILM Corporation, Tokyo (JP)

(72) Inventors: Hiroyuki YONEZAWA, Minamiashigara-shi (JP); Aki Nakamichi, Minamiashigara-shi (JP); Takuya Kitamura, Minamiashigara-shi (JP); Yusuke Hatanaka, Minamiashigara-shi (JP)

(73) Assignee: FUJIFILM Corporation, Tokyo (JP)

(21) Appl. No.: 17/069,139

(22) Filed: Oct. 13, 2020

Related U.S. Application Data
(63) Continuation of application No. PCT/JP2019/014636, filed on Apr. 2, 2019.

(30) Foreign Application Priority Data
May 11, 2018 (JP) 2018-092467

(51) Int. Cl. C09D 183/02; C09D 139/06; C09D 7/61; C09D 7/40; C09D 7/20; C09D 5/00; F21S 45/00; G02B 1/18; B32B 27/36; B32B 27/30

(52) U.S. Cl. CPC C09D 183/02; C09D 139/06; C09D 7/61; C09D 7/67; C09D 7/20; B32B 2255/26; F21S 45/00; G02B 1/18; B32B 27/365; B32B 27/308; C09D 5/00

(57) ABSTRACT

A coating agent includes a hydrolyzate of a compound represented by General Formula (1), silica particles, a high boiling point solvent having a boiling point of 120° C. or higher, and a resin having a pyrrolidone group in a side chain. In General Formula (1), R¹, R², R³, and R⁴ each independently represent a monovalent organic group having 1 to 6 carbon atoms. n represents an integer of 1 to 20,

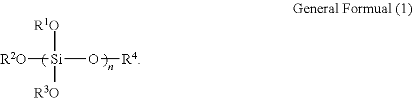

### CROSS-REFERENCE TO RELATED APPLICATIONS

This application is a Continuation of PCT International Application No. PCT/JP2019/014636 filed on Apr. 2, 2019, which claims priority under 35 U.S.C § 119(a) to Japanese Patent Application No. 2018-092467 filed on May 11, 2018. Each of the above application(s) is hereby expressly incorporated by reference, in its entirety, into the present application.

### BACKGROUND OF THE INVENTION

### 1. Field of the Invention

The present disclosure relates to a coating agent, an anti-fogging film, a method for manufacturing an anti-fogging film, and a laminate.

### 2. Description of the Related Art

Since devices, building materials, and the like that are installed indoors or outdoors and used for a long time are exposed to various environments, they are gradually accumulated with dust, rubbish, gravel, or the like and wet by rainwater during winding and raining or the like, whereby planned functions and performance may be impaired.

Considering such situations, a method of providing a hydrophilic film on a device, a building material, or the like is widely known.

As the hydrophilic film, JP2016-164265A discloses a hydrophilic film including a siloxane binder and silica particles and satisfying a predetermined relationship between the surface area difference ΔS on the surface and the surface roughness Ra.

In addition, JP2005-314495A discloses an anti-fogging paint containing a colloidal silica sol (A) formed using a basic catalyst, and a hydrophilic polymer (B).

### SUMMARY OF THE INVENTION

In a case of lamps mounted in an automobile (for example, a head lamp, a tail lamp, a door mirror turn signal lamp), high humidity air may enter the lamp chamber, the lens may be cooled by the outside air, rainfall, or the like, and moisture may be condensed on the inner surface of the lens, thereby causing fogging. Therefore, a hydrophilic film including silica particles is provided on the inner surface of the lens. In addition to preventing fogging (that is, anti-fogging ability), the hydrophilic film is desired to have haze reduction ability for improving the aesthetic appearance of the lens surface and contamination resistance for maintaining the anti-fogging ability.

However, both the hydrophilic film disclosed in JP2016-164265A and the anti-fogging film obtained from the anti-fogging paint disclosed in JP2005-314495A have an anti-fogging property but there is room for improvement in the reduction of haze and contamination resistance. In particular, the anti-fogging film obtained from the anti-fogging paint disclosed in the above-described JP2005-314495A has an additional problem that a “water drooping trace” appears when the hydrophilic polymer (B) is eluted in water.

In consideration of the above-described circumstances, an object to be achieved by one embodiment of the present invention is to provide a coating agent capable of forming an anti-fogging film having a low haze and excellent in anti-fogging property and contamination resistance.

In addition, another object to be achieved by one embodiment of the present invention is to provide an anti-fogging film having a low haze and excellent in the anti-fogging property and contamination resistance, a method for manufacturing the anti-fogging film, or a laminate.

Here, the haze represents the degree of diffusion of light rays incident on the hydrophilic film and is indicated by the proportion of diffusion transmittance with respect to the total light rays transmittance as a percentage.

In addition, the term “contamination resistance” means that the accumulation of contaminants is reduced in the hydrophilic film and the anti-fogging ability is maintained.

Specific means for solving the problems include the following aspects.

<1> A coating agent comprising: a hydrolyzate of a compound represented by General Formula (1); silica particles; a high boiling point solvent having a boiling point of 120° C. or higher; and a resin having a pyrrolidone group in a side chain.

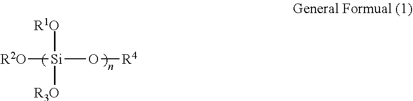

In General Formula (1), R¹, R², R³, and R⁴ each independently represent a monovalent organic group having 1 to 6 carbon atoms. n represents an integer of 1 to 20.

<2> The coating agent according to <1>, further comprising a metal chelate compound as a condensation catalyst.

<3> The coating agent according to <1> or <2>, in which the resin having a pyrrolidone group in a side chain is a resin containing a constitutional unit derived from vinylpyrrolidone.

<4> The coating agent according to any one of <1> to <3>, in which the resin having a pyrrolidone group in a side chain is a resin containing a constitutional unit derived from vinylpyrrolidone and a constitutional unit derived from a monomer having a C log P value of 0.7 to 3.0.

<5> The coating agent according to <4>, in which the constitutional unit derived from the monomer having a C log P value of 0.7 to 3.0 is a constitutional unit derived from vinyl acetate.

<6> The coating agent according to any one of <1> to <5>, in which a content of the resin having a pyrrolidone group in a side chain is 30% by mass to 60% by mass with respect to a mass of the silica particles.

<7> The coating agent according to any one of <1> to <6>, in which an average primary particle diameter of the silica particles is 10 nm to 20 nm.

<8> The coating agent according to any one of <1> to <7>, in which a content of the silica particles with respect to a total solid content is 45% by mass or more.

<9> The coating agent according to any one of <1> to <8>, in which the high boiling point solvent has a boiling point of 140° C. or higher.

<10> The coating agent according to <9>, in which the high boiling point solvent has a boiling point of 150° C. or higher.

<11> The coating agent according to any one of <1> to <10>, in which the high boiling point solvent is a glycol ether-based solvent.

<12> The coating agent according to any one of <1> to <11>, in which the high boiling point solvent is a solvent having a branched alkyl group.

<13> The coating agent according to any one of <1> to <12>, further comprising water.

<14> The coating agent according to any one of <1> to <13>, in which a content of the high boiling point solvent is 10% by mass to 50% by mass with respect to a total mass of all solvents contained in the coating agent.

<15> An anti-fogging film formed of the coating agent according to any one of <1> to <14>.

<16> An anti-fogging film comprising: a hydrolyzate of a compound represented by General Formula (1); silica particles; and a resin having a pyrrolidone group in a side chain, in which the anti-fogging film has a haze of 2.0 or less.

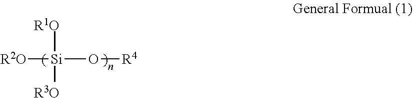

In General Formula (1), R¹, R², R³, and R⁴ each independently represent a monovalent organic group having 1 to 6 carbon atoms. n represents an integer of 1 to 20.

<17> A method for manufacturing an anti-fogging film comprising:

a step of applying the coating agent according to any one of <1> to <14> to a material to be coated; and

a step of drying the applied coating agent.

<18> A laminate comprising: a base material; and an anti-fogging film formed of the coating agent according to any one of <1> to <14>, which is provided on the base material.

<19> A laminate comprising: a base material; and an anti-fogging film having a haze of 2.0 or less, which is provided on the base material, the anti-fogging film including a hydrolyzate of a compound represented by General Formula (1), silica particles, and a resin having a pyrrolidone group in a side chain.

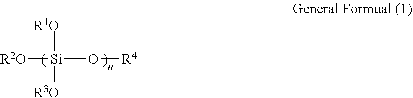

In General Formula (1), R¹, R², R³, and R⁴ each independently represent a monovalent organic group having 1 to 6 carbon atoms. n represents an integer of 1 to 20.

<20> The laminate according to <18> or <19>, in which the base material is a polycarbonate base material or a polymethylmethacrylate base material.

According to one embodiment of the present invention, a coating agent capable of forming an anti-fogging film having a low haze and excellent in the anti-fogging property and contamination resistance is provided.

According to another embodiment of the present invention, an anti-fogging film having a low haze and excellent in the anti-fogging property and contamination resistance, a method for manufacturing anti-fogging film, or a laminate is provided.

### DESCRIPTION OF THE PREFERRED EMBODIMENTS

Hereinafter, one embodiment of a coating agent, an anti-fogging film, a method for manufacturing an anti-fogging film, and a laminate according to the present disclosure will be described in detail.

In the present disclosure, the numerical range indicated by using “to” means a range including the numerical values before and after “to” as the minimum value and the maximum value, respectively.

In the present disclosure, in a case of referring to an amount of each component in a composition, in a case where there are a plurality of substances corresponding to each component in the composition, unless otherwise particularly specified, the amount means the total amount of the plurality of components present in the composition.

In the numerical ranges described stepwise in the present disclosure, the upper limit value or the lower limit value described in one numerical range may be replaced with the upper limit value or the lower limit value of the numerical range described stepwise in other stages. Further, in the numerical ranges described in the present disclosure, the upper limit value or the lower limit value of the numerical range may be replaced with the value shown in Examples.

The term “solid content” in the present disclosure means a component excluding a solvent, and a liquid component such as a low molecular weight component other than the solvent is also included in the “solid content” in the present disclosure.

In the present disclosure, “solvent” means water, an organic solvent, and a mixed solvent of water and an organic solvent.

In the present disclosure, a hydrophile lipophile balance value may be referred to as an HLB value.

<Coating Agent>

A coating agent according to the present disclosure includes: a hydrolyzate of a compound represented by General Formula (1); silica particles; a high boiling point solvent having a boiling point of 120° C. or higher; and a resin having a pyrrolidone group in a side chain.

Hereinafter, the compound represented by General Formula (1) is also referred to as a specific siloxane compound, and the hydrolyzate of the specific siloxane compound is also referred to as a specific siloxane hydrolyzate.

The coating agent including each component described above is capable of forming an anti-fogging film having a low haze and excellent in the anti-fogging property and contamination resistance.

The reason why such effects are exhibited is speculated as follows. However, the coating agent according to the present disclosure is not limited by the following reasons.

To obtain a hydrophilic film including silica particles, a coating agent including silica particles is used. The hydrophilic film is formed by applying the coating agent including silica particles to a material to be coated and drying the applied coating agent. However non-uniform aggregation of silica particles may occur during from the drying step to the coating step, whereby the formed film is whitish and the haze increase. In particular, in a case where a roughness derived from the non-uniform aggregation of the silica particles is formed on the surface of the hydrophilic film, the haze increases due to the roughness on the surface.

On the other hand, one factor of the anti-fogging ability of the hydrophilic film is obtained by the void formed between the silica particles. However, in a case where the void sizes are not uniform in the hydrophilic film, incident light may diffuse, the haze increase, and the anti-fogging ability itself decrease. Further, in a case where a void having a large size are locally formed between silica particles in the hydrophilic film, water vapor may be absorbed in the large void and be whitely turbid, which increases the haze. Furthermore, in a case where the void having a large size are locally formed between the silica particles in the hydrophilic film, contaminants such as hydrocarbon gas and silicone oil may be gradually incorporated and accumulated, which results in the problem of the decrease in the anti-fogging ability.

The coating agent according to the present disclosure contains a high boiling point solvent and a resin having a pyrrolidone group in a side chain, together with a hydrolyzate of a compound represented by General Formula (1) and silica particles, whereby a film forming behavior of the coating agent including silica particles is controlled in the coating step and the drying step, and a film having high surface smoothness and a film (that is, an anti-fogging film) having a substantially uniform void size can be formed. As a result, the formed anti-fogging film has a low haze and excellent in the anti-fogging property and contamination resistance.

Specifically, these properties are exhibited presumably because including the high boiling point solvent improves the levelability of the coating film by the coating agent, whereby smoothness of the formed film (that is, the anti-fogging film) is increased, and including the resin having a pyrrolidone group in a side chain increases the dispersibility of the silica particles, suppresses non-uniform aggregation, and makes the void size between the silica particles uniform by adsorbing and immobilizing the silica particle to the pyrrolidone group of the resin having a pyrrolidone group in a side chain. In particular, it is speculated that since the coating agent including a high boiling point solvent dries slowly, in the coating film of the coating agent, the adsorption of the silica particle to the pyrrolidone group of the resin having a pyrrolidone group in a side chain and immobilization of the silica particles by the resin having a pyrrolidone group in a side chain are easily carried out sufficiently, whereby the uniformity of the void size between the silica particles can be enhanced.

Further, when the anti-fogging film is formed by the coating agent according to the present disclosure, at least some of the hydroxy groups contained in the hydrolyzate of the compound represented by General Formula (1) are intermolecularly bonded to each other, whereby the specific siloxane hydrolyzate is condensed. That is, the anti-fogging film formed of the coating agent according to the present disclosure includes a condensate of the specific siloxane hydrolyzate. It is speculated that the presence of this condensate makes it difficult for the anti-fogging film to elute in water, and can suppress the occurrence of “water drooping trace”.

Hereinafter, each component that may be included in the coating agent according to the present disclosure will be described.

[Specific Siloxane Hydrolyzate]

The coating agent according to the present disclosure includes the specific siloxane hydrolyzate (that is, a hydrolyzate of a specific siloxane compound represented by General Formula (1)). The specific siloxane compound has a structure in which at least a part thereof is hydrolyzed in a case where the specific siloxane compound coexists with water. Specifically, the specific siloxane compound reacts with water to substitute at least a part of OR¹, OR², OR³, and OR⁴ which are bonded to the silicon atom in General Formula (1) with a hydroxy group. Therefore, the specific siloxane hydrolyzate refers to a compound in which at least a part of OR¹, OR², OR³, and OR⁴ in General Formula (1) are substituted with a hydroxy group.

In a case where the coating agent includes the specific siloxane hydrolyzate, the anti-fogging film formed of the coating agent has a good retention property of the silica particles, which will be described later, scratch resistance is increased, and the hydrophilicity is improved due to the hydroxy group contained in the specific siloxane hydrolyzate. In a case where the hydrophilicity of the anti-fogging film is increased, water droplets can be converted into a water film on the surface of the anti-fogging film, and thus the anti-fogging property is further improved.

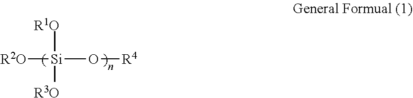

In General Formula (1), R¹, R², R³, and R⁴ each independently represent a monovalent organic group having 1 to 6 carbon atoms. n represents an integer of 1 to 20.

The monovalent organic group having 1 to 6 carbon atoms as R¹, R², R³, and R⁴ may be linear, branched, or cyclic. Examples of the monovalent organic group include an alkyl group and an alkenyl group, and an alkyl group is preferred.

Examples of the alkyl group represented by R¹, R², R³, or R⁴ include a methyl group, an ethyl group, a propyl group, an isopropyl group, an n-butyl group, a tert-butyl group, an n pentyl group, an n-hexyl group, and a cyclohexyl group.

In a case where the monovalent organic group as R¹ to R⁴ in the specific siloxane compound, preferably the alkyl group, has 1 to 6 carbon atoms, the specific siloxane compound has a good a hydrolyzation property. From the viewpoint of the better hydrolyzation property, it is preferable that R¹ to R⁴ are each independently an alkyl group having 1 to 4 carbon atoms and more preferable that R¹ to R⁴ are each independently an alkyl group having 1 or 2 carbon atoms.

In General Formula (1), n represents an integer of 1 to 20. In a case where n is 1 or more, the reactivity of the specific siloxane compound is easily controlled, and, for example, a film excellent in surface hydrophilicity can be formed. In a case where n is 20 or less, the viscosity of the coating agent is not too high, and the handleability and uniform coating property is improved. From the viewpoint of easily controlling the hydrolysis reaction, n is preferably 3 to 12 and more preferably 5 to 10.

In Table 1 below, examples of specific siloxane compounds are listed according to R¹, R², R³, R⁴, and n in General Formula (1). However, the specific siloxane compound in the present disclosure is not limited to the exemplary compounds listed in Table 1.

TABLE 1

| Specific siloxane | | | | | |
|---|---|---|---|---|---|
| compound | R¹ | R² | R³ | R⁴ | n |
| Compound 1 | Methyl | Methyl | Methyl | Methyl | 5 |
| Compound 2 | Methyl | Methyl | Methyl | Methyl | 10 |
| Compound 3 | Ethyl | Ethyl | Ethyl | Ethyl | 5 |
| Compound 4 | Ethyl | Ethyl | Ethyl | Ethyl | 10 |
| Compound 5 | Ethyl | Ethyl | Ethyl | Ethyl | 1 |

As the specific siloxane compound, a commercial product can be used.

As the commercial product of the specific siloxane compound, MKC (registered trademark) silicate MS51 [R¹, R², R³, and R⁴: methyl group, average of n: 5], MKC (registered trademark) silicate MS56 [R¹, R², R³, and R⁴: methyl group, average of n: 11], MKC (registered trademark) silicate MS57 [R¹, R², R³, and R⁴: methyl group, average of n: 13], MKC (registered trademark) silicate MS56S [R¹, R², R³, and R⁴: methyl group, average of n: 16], MKC (registered trademark) methyl silicate 53A [R¹, R², R³, and R⁴: methyl group, average of n: 7], MKC (registered trademark) ethyl silicate 40 [R¹, R², R³, and R⁴: ethyl group, average of n: 5], MKC (registered trademark) ethyl silicate 48 [R¹, R², R³, and R⁴: ethyl group, average of n: 10], and MKC (registered trademark) EMS 485 [R¹, R², R³, and R⁴: methyl group 50% and ethyl group 50%, average of n: 10], which are manufactured by Mitsubishi Chemical Corporation, tetraethoxysilane (TEOS) manufactured by Tokyo Chemical Industry Co., Ltd., and the like are mentioned.

For the specific siloxane hydrolyzate, it is not necessary for all of the terminal groups (that is, —OR¹, —OR², —OR³, or —OR⁴) of the specific siloxane compound to react. However, for example, from the viewpoint of further increasing the hydrophilicity of the anti-fogging film formed of the coating agent, it is preferable that more terminal groups are hydrolyzed.

The weight-average molecular weight of the specific siloxane compound is preferably in the range of 300 to 1,500 and more preferably in the range of 500 to 1,200.

In the present disclosure, the weight-average molecular weight can be measured by gel permeation chromatography (GPC). Specifically, HLC-8120GPC and SC-8020 (Tosoh Corporation) can be used for measurement by using two columns of TSKgel and SuperHM-H (Tosoh Corporation, 6.0 mm ID×15 cm) as columns and using tetrahydrofuran (THF) as an eluent. The measurement can be performed using a differential refractometer (RI) detector under the conditions of a sample concentration of 0.5% by mass, a flow rate of 0.6 ml/min, a sample injection amount of 10 μl (microliter), and a measurement temperature of 40° C. Calibration can be performed using the calibration curve created by using “polystyrene standard sample TSKstandard” by Tosoh Corporation, including 10 samples of “A-500”, “F-1”, “F-10”, “F-80”, “F-380”, “A-2500”, “F-4”, “F-40”, “F-128”, and “F-700”.

The coating agent according to the present disclosure may include only one kind of the specific siloxane hydrolyzate or may include two or more kinds thereof.

The coating agent according to the present disclosure can include a partial co-hydrolyzate obtained using two or more silane compounds. The two or more silane compounds may be specific siloxane compounds having structures different from each other or a combination of a specific siloxane compound and another siloxane compound having a structure different from the specific siloxane compound. A hydrolyzate obtained from two or more kinds of siloxane compounds is also referred to as a “(co)hydrolyzate”, and a compound obtained by condensing the (co)hydrolyzate is also referred to as a “condensate of the (co)hydrolyzate”.

The silane compound in the present disclosure refers to a compound having at least one group selected from a silyl group having the hydrolyzation property and a silanol group having the hydrolyzation property. The silyl group is hydrolyzed to a silanol group, and the silanol group is dehydrated and condensed, thereby generating a siloxane bond.

The content of the specific siloxane hydrolyzate in the coating agent is preferably 1% by mass to 50% by mass, more preferably 10% by mass to 40% by mass, and still more preferably 15% by mass to 35% by mass, with respect to the total solid content of the coating agent.

In a case where the content of the specific siloxane hydrolyzate is within the above range, the pure water contact angle on the surface of the anti-fogging film formed using the coating agent is suppressed to be small, whereby the anti-fouling property against water-based stains improves and the stains in a case of being stained are easily removed.

[Silica Particles]

The coating agent according to the present disclosure includes silica particles.

The silica particles have a function of enhancing scratch resistance of the hydrophilic film formed of the coating agent and, furthermore, exhibiting hydrophilicity. That is, the silica particles play the role of a hard filler, and the hydroxy groups on the particle surface act to contribute to the improvement of the hydrophilicity of the hydrophilic film.

Examples of the silica particles include fumed silica and colloidal silica.

The fumed silica can be obtained by reacting a compound containing a silicon atom with oxygen and hydrogen in a gas phase. An example of the silicon compound which is used as a raw material includes a silicon halide (for example, silicon chloride).

The colloidal silica can be synthesized by a sol-gel method in which a raw material compound is hydrolyzed and condensed. Examples of the raw material compound of the colloidal silica include an alkoxy silicon (for example, tetraethoxysilane) and a halogenated silane compound (for example, diphenyldichlorosilane).

The shape of the silica particles is not particularly limited, and a spherical shape, a plate shape, a needle shape, a rosary shape, or a shape in which two or more of these shapes are combined is mentioned. In addition, the term “spherical shape” here includes not only a true spherical shape but also a spheroidal shape, an oval shape, and the like.

The silica particles are also available as a commercial product.

As the commercial product of the silica particles, AEROSIL (registered trademark) series manufactured by Evonik Co., Ltd., SNOWTEX (registered trademark) series (for example, SNOWTEX O) manufactured by Nissan Chemical Corporation, Nalco (registered trademark) series (for example, Nalco 8699) manufactured by Nalco Chemical Co., and Quartron PL series (for example, PL-1) manufactured by Fuso Chemical Co., Ltd., and the like are mentioned.

The average primary particle diameter of the silica particles is preferably 100 nm or less, more preferably 50 nm or less, still more preferably 30 nm or less, and particularly preferably 20 nm or less, from the viewpoint that the hydrophilic film to be formed has good film properties and the haze is reduced. The lower limit of the average primary particle diameter of the silica particles is not particularly limited and is preferably 2 nm or more from the viewpoint of handleability and more preferably 10 nm or more from the viewpoint of easy formation of the void for exhibiting anti-fogging ability.

In particular, the average primary particle diameter of the silica particles is preferably 10 nm to 20 nm from the viewpoint of improving anti-fogging property and contamination resistance.

In a case where the shape of the silica particles is spherical, or substantially spherical and elliptical in cross section, the average primary particle diameter of the silica particles is determined by observing the dispersed silica particles under a transmission electron microscope, measuring the projected area of the particle from the obtained photograph with respect to 300 or more particles, calculating the equivalent circle diameter from the projected area, and defining the average primary particle diameter of the silica particles as the obtained equivalent circle diameter. In a case where the shape of the silica particles is not spherical or substantially spherical, another method, for example, the dynamic light scattering method is used to determine the average primary particle diameter of the silica particles.

The coating agent according to the present disclosure may include only one kind of the silica particle or may include two or more kinds thereof.

In a case where two or more kinds of the silica particles are included, particles having at least ones of sizes and shapes different from each other may be included.

From the fact that the anti-fogging film formed of the coating agent has good hydrophilicity and is excellent in the hardness and scratch resistance of the anti-fogging film, the content of the silica particles in the coating agent is preferably 30% by mass or more, more preferably 40% by mass or more, and still more preferably 45% by mass or more, with respect to the total solid content of the coating agent.

In addition, from the viewpoints of maintaining anti-fogging ability and ensuring the temporal stability of the coating agent, the upper limit of the content of silica particles is preferably 85% by mass with respect to the total solid content of the coating layer.

[High Boiling Point Solvent Having Boiling Point of 120° C. or Higher]

The coating agent according to the present disclosure includes a high boiling point solvent having a boiling point of 120° C. or higher (hereinafter, also simply referred to as a high boiling point solvent).

In a case where the coating agent according to the present disclosure includes a high boiling point solvent having a boiling point of 120° C. or higher, it is possible to obtain an anti-fogging film which has the improved levelability of the coating film in a case where the coating agent is applied and in which the haze is low and the smoothness of the surface is high. As a result, the obtained anti-fogging film is excellent in contamination resistance.

The boiling point of the high boiling point solvent is preferably 140° C. or higher and more preferably 150° C. or higher, from the viewpoint that the levelability of the coating film is further enhanced and an anti-fogging film having lower haze can be obtained.

The upper limit of the boiling point of the high boiling point solvent is preferably 230° C. from the viewpoint of suppressing the drying failure of the coating film due to the coating agent.

Examples of the high boiling point solvent include the followings. The numerical value in parentheses after a high boiling point solvent shown below indicates the boiling point thereof.

Examples of the high boiling point solvent include: alcohol-based solvents such as 1,3-butanediol (207° C.), 1,4-butanediol (228° C.), benzyl alcohol (205° C.), and terpineol (217° C.);

glycol-based solvents such as ethylene glycol (197° C.), diethylene glycol (244° C.), triethylene glycol (287° C.), propylene glycol (187° C.), and dipropylene glycol (230° C.);

glycol ether-based solvents such as diethylene glycol monomethyl ether (194° C.), diethylene glycol monoethyl ether (202° C.), diethylene glycol monobutyl ether (231° C.), triethylene glycol monomethyl ether (249° C.), propylene glycol monomethyl ether (121° C.), propylene glycol monobutyl ether (170° C.), propylene glycol monopropyl ether (150° C.), 3-methoxy-3-methyl-1-butanol (174° C.), diethylene glycol monohexyl ether (261° C. or higher), propylene glycol monomethyl ether propionate (160° C.), methyl cellosolve (ethylene glycol monomethyl ether (125° C.), ethyl cellosolve (ethylene glycol monoethyl ether (135° C.), butyl cellosolve (ethylene glycol monobutyl ether (171° C.), ethylene glycol mono-tert-butyl ether (153° C.), tripropylene glycol monomethyl ether (243° C.), and dipropylene glycol monomethyl ether (188° C.);

ether-based solvents such as diethylene glycol dimethyl ether (162° C.), diethylene glycol ethyl methyl ether (176° C.), diethylene glycol isopropyl methyl ether (179° C.), and triethylene glycol dimethyl ether (216° C.);

ester-based solvents such as ethylene glycol monomethyl ether acetate (145° C.), diethylene glycol monoethyl ether acetate (217° C.), ethyl acetate (154° C.), ethyl lactate (154° C.), and 3-methoxybutyl acetate (172° C.); and

ketone-based solvents such as diacetone alcohol (169° C.), cyclohexanone (156° C.), and cyclopentanone (131° C.).

Here, the alcohol-based solvent in the present disclosure refers to a solvent having a structure in which one carbon atom of a hydrocarbon is substituted with one hydroxy group.

The glycol-based solvent in the present disclosure refers to a solvent having a structure in which two or more carbon atoms of a hydrocarbon are each substituted with one hydroxy group.

The glycol ether-based solvent in the present disclosure refers to a solvent having a structure in which one hydroxy group and at least one ether group are included in one molecule.

The ether-based solvent in the present disclosure refers to a solvent having a structure in which a hydroxy group or an ester group is not included but at least one ether group is included in one molecule.

The ester-based solvent in the present disclosure refers to a solvent having a structure in which at least one ester group is included in one molecule.

The ketone-based solvent in the present disclosure refers to a solvent having a structure in which at least one ketone group is included in one molecule.

As the high boiling point solvent included in the coating agent, a glycol ether-based solvent is preferably used since the glycol ether-based solvent has low surface energy and the levelability of the coating film by the coating agent is enhanced.

For the same reason, as the high boiling point solvent included in the coating agent, a solvent having a branched alkyl group is preferably used.

The coating agent according to the present disclosure may include only one kind of the high boiling point solvent or may include two or more kinds thereof.

In a case where two or more high boiling point solvents are included, it is preferable to include a glycol ether-based solvent as one of the high boiling point solvents. In a case where the glycol ether-based solvent is included, the flatness of the coating film by the coating agent is improved.

The glycol ether-based solvent is preferably used in the range of 10% by mass to 40% by mass and more preferably in the range of 15% by mass to 30% by mass, in the total high boiling point solvent.

In a case where two or more high boiling point solvents are included, it is preferable to include a ketone-based solvent as one of the high boiling point solvents. In a case where the ketone-based solvent is included, the adhesiveness between the anti-fogging film formed of the coating agent and the base material is improved.

The ketone-based solvent is preferably used in the range of 5% by mass to 40% by mass and more preferably in the range of 5% by mass to 15% by mass, in the total high boiling point solvent.

In a case where two or more high boiling point solvents are included, the coating agent according to the present disclosure particularly preferably includes both a glycol ether-based solvent and a ketone-based solvent.

The ketone-based solvent as the high boiling point solvent is preferably a ketone-based solvent having a solubility parameter (SP) value of 10.0 MPa^{1/2} or more from the viewpoint that an anti-fogging film having more excellent transparency can be formed. The upper limit of the SP value of the ketone-based solvent is not particularly limited and is preferably 13.0 MPa^{1/2} or less from the viewpoint of coating property on the base material, for example, the viewpoint that surface failure such as cissing does not occur easily.

Specific examples of the ketone-based solvent having a high boiling point solvent and an SP value of 10.0 MPa^{1/2} or more are described below, but the specific examples are not limited thereto. The numerical value in parentheses after the following specific examples indicates the SP value (unit: MPa^{1/2}).

Diacetone alcohol (10.2), cyclopentanone (10.4).

The above SP value is a value represented by the square root of the molecular cohesive energy and calculated by the method described in R. F. Fedors, Polymer Engineering Science, 14, p 147 to p 154 (1974).

The content of the high boiling point solvent in the coating agent according to the present disclosure is preferably 15% by mass to 60% by mass, more preferably 20% by mass to 50% by mass, and still more preferably 20% by mass to 40% by mass, with respect to the total mass of the coating agent.

The high boiling point solvent in the coating agent according to the present disclosure is preferably used in combination with a solvent other than the high boiling point solvent, which will be described below.

In a case where the high boiling point solvent and the solvent other than the high boiling point solvent are included, the content of the high boiling point solvent is preferably 10% by mass to 50% by mass, preferably 10% by mass to 40% by mass, and still more preferably 15% by mass to 35% by mass, with respect to the total mass of all the solvents included in the coating agent.

[Resin Having Pyrrolidone Group in Side Chain]

The coating agent according to the present disclosure includes a resin having a pyrrolidone group in a side chain.

The pyrrolidone group in the resin having a pyrrolidone group in a side chain is represented by the following structure.

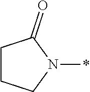 [SMILES: *N1CCCC1=O]

In the above structure, “*” represents a linking site between the pyrrolidone group in the resin having a pyrrolidone group in a side chain and another structure.

The resin having a pyrrolidone group in a side chain may be a homopolymer or copolymer of a monomer having a pyrrolidone group or may be a resin obtained by introducing a pyrrolidone group, by a polymer reaction, into a side chain of a resin synthesized in advance.

The resin having a pyrrolidone group in a side chain is preferably a homopolymer or copolymer of a monomer having a pyrrolidone group from the viewpoint that the amount of the pyrrolidone group to be introduced is easily adjusted and the resin is easily available. That is, the resin having a pyrrolidone group in a side chain according to the present disclosure is preferably a resin containing a constitutional unit derived from N-vinyl-2-pyrrolidone.

In a case where the resin having a pyrrolidone group in a side chain in the present disclosure is a resin containing a constitutional unit derived from vinylpyrrolidone (that is, N-vinyl-2-pyrrolidone), the proportion of the constitutional unit derived from vinylpyrrolidone is preferably 30% by mass or more and the upper limit of the proportion may be 100% by mass with respect to all the constitutional units.

More preferably, the proportion of the constitutional unit derived from vinylpyrrolidone in the resin having a pyrrolidone group in a side chain is preferably 40% by mass to 90% by mass and more preferably 50% by mass to 80% by mass with respect to all the constitutional units, from the viewpoints of solubility in the high boiling point solvent or a solvent other than the high boiling point solvent and adsorption property to the silica particles.

The resin having a pyrrolidone group in a side chain in the present disclosure is preferably a resin containing a constitutional unit derived from vinylpyrrolidone and a constitutional unit derived from a monomer having a C log P value of 0.7 to 3.0, from the viewpoints of solubility in the high boiling point solvent or a solvent other than the high boiling point solvent and the adsorption property to the silica particles.

The C log P value is a value obtained by calculating the common logarithm log P of the partition coefficient P between 1-octanol and water. Known methods and software can be used for calculating the C log P value, but unless otherwise specified, in the present disclosure, the C log P program incorporated in ChemBioDraw Ultra 12.0 of CambridgeSoft Corporation is used.

The larger the C log P value is, the larger the hydrophobicity is.

As the constitutional unit derived from a monomer having a C log P value of 0.7 to 3.0, a constitutional unit derived from vinyl acetate (C log P value: 0.8), styrene (C log P value: 2.9), butyl methacrylate (C log P value: 2.7), methyl methacrylate (C log P value: 1.1), or the like is mentioned.

Among them, vinyl acetate is preferred as the constitutional unit derived from the monomer having a C log P value of 0.7 to 3.0, from the viewpoint of easy availability.

That is, the resin having a pyrrolidone group in a side chain according to the present disclosure is preferably a resin containing a constitutional unit derived from vinylpyrrolidone and a constitutional unit derived from vinyl acetate.

Here, in the resin containing a constitutional unit derived from vinylpyrrolidone and a constitutional unit derived from a monomer having a C log P value of 0.7 to 3.0, the proportion of the constitutional unit derived from vinylpyrrolidone is within the same range described above, and the preferred range is also the same as described above.

The resin having a pyrrolidone group in a side chain in the present disclosure may include a constitutional unit derived from vinylpyrrolidone and a constitutional unit (hereinafter, also referred to as other constitutional units) other than the constitutional unit derived from a monomer having a C log P value of 0.7 to 3.0 in the range that does not interfere with the adsorption property to the silica particles.

Examples of the other constitutional units include constitutional units derived from monomers such as acrylic acid, methacrylic acid, an EO-modified acrylate, a PO-modified acrylate, hydroxyethyl acrylate, acrylamide, and acryloylmorpholine.

In a case where the resin having a pyrrolidone group in a side chain in the present disclosure contains a constitutional unit other than the constitutional unit derived from vinylpyrrolidone (including a constitutional unit derived from a monomer having a C log P value of 0.7 to 3.0), the proportion of the other constitutional units is preferably 70% by mass or less, more preferably 10% by mass to 60% by mass, and still more preferably 20% by mass to 50% by mass, with respect to all the constitutional units.

In addition, the weight-average molecular weight (Mw) of the resin having a pyrrolidone group in a side chain is 10,000 to 100,000, more preferably 20,000 to 80,000, and still more preferably 30,000 to 60,000, from the viewpoints of the exhibition of adsorption property to the silica particles, improvement of the dispersibility of the silica particles, the uniformization of the void size between the silica particles, and the like.

The resin having a pyrrolidone group in a side chain is also available as a commercial product.

Examples of the commercial product of the resin having a pyrrolidone group in a side chain in the present disclosure include: PVP/VAS-630 (a copolymer of 60% by mass of a constitutional unit derived from vinylpyrrolidone and 40% by mass of a constitutional unit derived from vinyl acetate, weight-average molecular weight: 51,000, solid content: 100% by mass), PVP/VAE-735 (a copolymer of 70% by mass of a constitutional unit derived from vinylpyrrolidone and 30% by mass of a constitutional unit derived from vinyl acetate, weight-average molecular weight: 56,700, a solution of 50% by mass of ethanol), PVP/VAE-635 (a copolymer of 60% by mass of a constitutional unit derived from vinylpyrrolidone and 40% by mass of a constitutional unit derived from vinyl acetate, weight-average molecular weight: 38,200, a solution of 50% by mass of ethanol), PVP/VAE-535 (a copolymer of 50% by mass of a constitutional unit derived from vinylpyrrolidone and 50% by mass of a constitutional unit derived from vinyl acetate, weight-average molecular weight: 36,700, a solution of 50% by mass of ethanol), PVP/VAE-335 (a copolymer of 30% by mass of a constitutional unit derived from vinylpyrrolidone and 70% by mass of a constitutional unit derived from vinyl acetate, weight-average molecular weight: 28,800, a solution of 50% by mass of ethanol), PVP/VAI-735 (a copolymer of 70% by mass of a constitutional unit derived from vinylpyrrolidone and 30% by mass of a constitutional unit derived from vinyl acetate, weight-average molecular weight: 22,300, a solution of 50% by mass of IPA (isopropyl alcohol)), PVP/VAI-535 (a copolymer of 50% by mass of a constitutional unit derived from vinylpyrrolidone and 50% by mass of a constitutional unit derived from vinyl acetate, weight-average molecular weight: 19,500, solution of 50% by mass of IPA), PVP/VAI-335 (a copolymer of 35% by mass of a structural unit derived from vinylpyrrolidone and 65% by mass of a constitutional unit derived from vinyl acetate, weight-average molecular weight: 12,700, a solution of 50% by mass of IPA), and PVP/VAW-735 (a copolymer of 70% by mass of a constitutional unit derived from vinylpyrrolidone and 30% by mass of a constitutional unit derived from vinyl acetate, weight-average molecular weight: 27,300, a 50% by mass aqueous solution), all of which are manufactured by Ashland Japan; LUVISKOL series (VA37E, VA37I, VA55I, VA64P, VA73E, VA73W) manufactured by BASF SE; and Pitskol (registered trademark) K-30 (a homopolymer of vinylpyrrolidone, weight-average molecular weight: 45,000, manufactured by Dai-ichi Kogyo Seiyaku Co., Ltd.).

The coating agent according to the present disclosure may include only one kind of the resin having a pyrrolidone group in a side chain or may include two or more kinds thereof.

The content of the resin having a pyrrolidone group in a side chain in the coating agent is preferably in the range of 20% by mass to 70% by mass, more preferably in the range of 25% by mass to 65% by mass, and still more preferably in the range of 30% by mass to 60% by mass, with respect to the silica particles.

[Other Components]

The coating agent according to the present disclosure may include other components in addition to the specific siloxane hydrolyzate, the silica particles, the high boiling point solvent, and the resin having a pyrrolidone group in a side chain in the range that does not impair the effects according to the present disclosure.

Examples of the other components include a condensation catalyst that accelerates the condensation reaction of the specific siloxane hydrolyzate, a solvent other than the high boiling point solvent, a nonionic surfactant, a resin having no pyrrolidone group, and an additive but are not limited to the components described above.

(Condensation Catalyst that Accelerates the Condensation Reaction of the Specific Siloxane Hydrolyzate)

The coating agent according to the present disclosure preferably includes the condensation catalyst (hereinafter, also simply referred to as “condensation catalyst”) that accelerates the condensation reaction of the specific siloxane hydrolyzate.

In a case where the condensation catalyst is included, the condensation reaction of the specific siloxane hydrolyzate is promoted, and thus the film forming property of the anti-fogging film by the coating agent is enhanced.

The condensation catalyst is not particularly limited as long as it accelerates the condensation reaction of the specific siloxane hydrolyzate, and examples thereof include an acid catalyst, an alkali catalyst, and an organometallic catalyst.

Examples of the acid catalyst include nitric acid, hydrochloric acid, sulfuric acid, acetic acid, phosphoric acid, chloroacetic acid, formic acid, oxalic acid, toluene sulfonic acid, xylene sulfonic acid, cumene sulfonic acid, dinonylnaphthalene monosulfonic acid, dinonylnaphthalene disulfonic acid, dodecylbenzene sulfonic acid, polyphosphate, and metaphosphate.

Examples of the alkali catalyst include sodium hydroxide, potassium hydroxide, tetramethylammonium hydroxide, sodium hydrogen carbonate, and urea.

Examples of the organometallic catalyst include: aluminum chelate compounds such as a metal chelate compound (aluminum bis(ethylacetoacetate) mono(acetylacetonate), aluminum tris(acetylacetonate), and aluminum ethylacetoacetate diisopropylate, zirconium chelate compounds such as zirconium tetrakis (acetylacetonate) and zirconium bis(butoxy)bis(acetylacetonate), and titanium chelate compounds such as titanium tetrakis (acetylacetonate) and titanium bis(butoxy)bis(acetylacetonate); organotin compounds such as dibutyltin diacetate, dibutyltin dilaurate, and dibutyltin dioctiate, aluminum alkoxides such as aluminum ethylate, aluminum isopropylate, and aluminum sec-butyrate, titanium alkoxides such as titanium (IV) ethoxide, titanium isopropoxide, and titanium (IV) n-butoxide, and zirconium alkoxides such as zirconium (IV) ethoxide, zirconium (IV) n-propoxide, and zirconium (IV) n-butoxide.

Among these catalysts, the acid catalyst is preferably phosphoric acid, toluene sulfonic acid, polyphosphate, or metaphosphate, the alkali catalyst is preferably sodium bicarbonate or urea, and the organometallic catalyst is preferably an aluminum chelate compound or a metal chelate compound such as a titanium chelate compound or a zirconium chelate compound. Among these catalysts, a metal chelate compound is more preferred, and an aluminum chelate compound is particularly preferred, each of which is an organometallic catalyst.

In a case where the coating agent according to the present disclosure includes a condensation catalyst, the content of the condensation catalyst is preferably 0.1% by mass to 40% by mass, more preferably 1% by mass to 30% by mass, and still more preferably 5% by mass to 20% by mass, with respect to the total solid content.

In a case where the content of the condensation catalyst is within the above range, it is easy to form an anti-fogging film having scratch resistance. In addition, the ability to form an anti-fogging film is excellent.

(Solvent Other than High Boiling Point Solvent)

The coating agent according to the present disclosure preferably includes a solvent other than the high boiling point solvent.

As the solvent other than the high boiling point solvent, water and an organic solvent having a boiling point of less than 120° C. are mentioned.

—Water—

The coating agent according to the present disclosure preferably includes water.

As described above, the water contributes to the hydrolysis reaction of the specific siloxane compound.

The water is preferably ion exchange water, pure water, distilled water, or the like from the viewpoint of fewer impurities.

The content of the water in the coating agent is preferably in the range of 5% by mass to 60% by mass, more preferably in the range of 10% by mass to 55% by mass, and still more preferably in the range of 10% by mass to 35% by mass, with respect to the total mass of the coating agent.

—Organic Solvent Having Boiling Point of Less than 120° C.—

The coating agent according to the present disclosure preferably includes an organic solvent having a boiling point of less than 120° C.

Examples of the organic solvent having a boiling point of less than 120° C. include: alcohol-based solvents such as methanol, ethanol, butanol, 2-methyl-1-butanol, 2-methyl-2-butanol, n-propanol, 2-propanol, tert-butanol, and 2-butanol;

glycol ether-based solvent such as dipropylene glycol methyl ether;

ether-based solvents such as isopropyl ether, 1,4-dioxane, tert-butyl methyl ether, tetrahydrofuran, 2-methyltetrahydrofuran, 1,2-dimethoxyethane, and diethyl ether; and

A ketone-based solvent such as acetone, acetylacetone, methyl ethyl ketone, methyl isobutyl ketone, and diisobutyl ketone.

As the organic solvent having a boiling point of less than 120° C., an alcohol-based solvent is preferred from the viewpoints of low surface energy and enhancing the wetting and spreading property of the coating agent.

In the coating agent according to the present disclosure, only one kind of the organic solvent having a boiling point of less than 120° C. may be used, or two or more thereof may be used.

In a case where two or more organic solvents having a boiling point of less than 120° C. are used, a ketone-based solvent may be used as one of the organic solvents to improve the adhesiveness between the anti-fogging film formed of the coating agent and the base material. As the ketone-based solvent used in this case, acetone (10.0) and acetylacetone (10.3), each of which has an SP value of 10.0 MPa^{1/2} or more, are preferred. The numerical value in parentheses indicates the SP value.

Regardless of the boiling point, the ketone-based solvent is preferably used in the range of 1% by mass to 15% by mass and more preferably in the range of 3% by mass to 10% by mass, in the total solvent.

In a case where the coating agent according to the present disclosure includes an organic solvent having a boiling point of less than 120° C., the content of the organic solvent having a boiling point of less than 120° C. is preferably in the range of 20% by mass to 75% by mass and more preferably in the range of 25% by mass to 65% by mass, with respect to the total mass of the coating agent.

(Nonionic Surfactant)

The coating agent according to the present disclosure preferably includes a nonionic surfactant.

Since the coating agent according to the present disclosure includes the nonionic surfactant, the surface tension of the coating agent is lowered. As a result, the coating property of the coating agent can be enhanced, and furthermore, surface smoothness of the anti-fogging film formed of the coating agent can be further enhanced. In addition, in a case where the anti-fogging film includes the nonionic surfactant, the adhesion preventing property to the contaminants can be enhanced.

Furthermore, since the nonionic surfactant is nonionic, the quantity of the electrolyte in the system does not increase, the aggregation of the silica particles can be suppressed, and the anti-fogging property can be improved.

Examples of the nonionic surfactant include a polyalkylene glycol monoalkyl ether, a polyalkylene glycol monoalkyl ester, and a polyalkylene glycol monoalkyl ester/monoalkyl ether.

Specific examples of the nonionic surfactant include polyethylene glycol monolauryl ether, polyethylene glycol monostearyl ether, polyethylene glycol monocetyl ether, polyethylene glycol monolauryl ester, and polyethylene glycol monostearyl ester.

In a case where the coating agent according to the present disclosure includes the nonionic surfactant, it is preferable to use a nonionic surfactant (hereinafter, also referred to as “specific nonionic surfactant”) having an HLB value (that is, hydrophilic-lipophilic balance value) of more than 15, from the viewpoint of forming an anti-fogging film that is more excellent in hydrophilicity and adhesion preventing property to the contaminants.

In a case where the coating agent according to the present disclosure includes the specific nonionic surfactant, the hydrophilicity of the formed anti-fogging film is further improved, and the adhesion preventing property to the contaminants (for example, hydrocarbon gas and silicone oil) that are hydrophobic components is good.

The HLB value of the specific nonionic surfactant is preferably 15.5 or more, more preferably 16 or more, still more preferably 17 or more, and particularly preferably 18 or more.

The upper limit of the HLB value of the specific nonionic surfactant is not particularly limited and is preferably, for example, 20 or less.

The HLB value of the surfactant in the present disclosure is a value defined by Formula (I) by the Griffin method (refer to Introduction of surfactants, all revised edition, p 128) and obtained by calculation.

HLB value of surfactant=(molecular weight of hydrophilic group moiety/molecular weight of surfactant)×20 (I)

As the specific nonionic surfactants, a polyoxyalkylene alkyl ether, a polyoxyalkylene alkylphenol ether, a polyoxyalkylene aryl ether, a polyoxyalkylene alkylaryl ether, a sorbitan derivative, a formalin condensate of a polyoxyalkylene aryl ether, a formalin condensate of a polyoxyalkylene alkyl aryl ether, polyethylene glycol, and the like are mentioned.

Among these, the specific nonionic surfactant is particularly preferably a polyoxyalkylene alkyl ether.

Examples of the alkyl group of the polyoxyalkylene alkyl ether in the specific nonionic surfactant include a linear alkyl group having 1 to 36 carbon atoms and a branched alkyl group having 3 to 36 carbon atoms.

Further, the oxyalkylene moiety of the polyoxyalkylene alkyl ether is preferably polyoxyethylene from the viewpoint that an anti-fogging film having particularly excellent hydrophilicity can be formed. In addition, the number of the polyoxyethylene structural units contained in the specific nonionic surfactant is preferably 6 or more, more preferably 10 or more, still more preferably 15 or more, and particularly preferably 20 or more. Further, the number of the polyoxyethylene structural units can be, for example, 100 or less from the viewpoint of solubility.

In a case where the specific nonionic surfactant is a polyoxyalkylene alkyl ether, the surfactant represented by Formula (II) is preferred.

RO—(C₂H₄O)ₘ—H (II)

In Formula (II), m represents an integer of 6 to 100. R represents a linear alkyl group having 1 to 36 carbon atoms or a branched alkyl group having 3 to 36 carbon atoms.

As the specific nonionic surfactant, a commercial product can be used.

Examples of the commercial product of the specific nonionic surfactant include: EMALEX (registered trademark) 715 (HLB value: 15.6), EMALEX (registered trademark) 720 (HLB value: 16.5), EMALEX (registered trademark) 730 (HLB value: 17.5), and EMALEX (registered trademark) 750 (HLB value: 18.4) (all of which are trade names, polyoxyethylene lauryl ether), all of which are manufactured by Nihon Emulsion Co., Ltd.; Leodol TW-P120 (trade name, polyoxyethylene sorbitan monopalmitate, HLB value: 15.6) manufactured by Kao Corporation; and PEG2000 (trade name, HLB value: 19.9) manufactured by Sanyo Chemical Industries, Ltd.

In a case where the coating agent according to the present disclosure includes the nonionic surfactant, only one kind of the nonionic surfactant may be included, or two or more kinds thereof may be included.

In a case where the coating agent according to the present disclosure includes the nonionic surfactant (preferably the specific nonionic surfactant), the content of the nonionic surfactant in the coating agent is preferably 0.01% by mass or more and 15% by mass or less, more preferably 0.1% by mass or more and 10% by mass or less, and still more preferably 1% by mass or more and 10% by mass or less, with respect to the total solid content.

Within the above range, the hydrophilicity of the formed anti-fogging film is good, and the adhesion preventing property to the contaminants which are hydrophobic components is good.

(Resin Having No Pyrrolidone Group)

The coating agent according to the present disclosure may include, as necessary, a resin having no pyrrolidone group in addition to the components described above.

Here, the resin having no pyrrolidone group refers to a resin having no pyrrolidone group in the molecule of the resin itself, which is included in the above-described resin having a pyrrolidone group in a side chain.

Specific examples of the resin having no pyrrolidone group include an acrylic resin, a cellulose resin, a vinyl alcohol resin, a urethane resin, and a vinyl acetal resin.

In a case where the resin having no pyrrolidone group is included in the coating agent according to the present disclosure, the content of the resin having no pyrrolidone group is preferably in the range of 5% by mass to 50% by mass and more preferably in the range of 5% by mass to 20% by mass, with respect to the total mass of the resin having a pyrrolidone group in a side chain and the resin having no pyrrolidone group.

(Other Additives)

The coating agent according to the present disclosure may further include, as necessary, other additives in addition to the components described above.

Examples of the other additives include an adhesion aid used for purposes such as improving the film property of the anti-fogging film formed of the coating agent and improving the adhesiveness with the base material, an antistatic agent which is used for improving the effect of preventing contaminants from adhering, a UV light absorber which prevents deterioration due to light, and an antioxidant which prevents deterioration due to heat.

<Method for Preparing Coating Agent>

The coating agent according to the present disclosure is prepared by mixing the specific siloxane hydrolyzate, the silica particles, the high boiling point solvent, and the resin having a pyrrolidone group in a side chain, and, as necessary, the optional components described above.

The specific siloxane hydrolyzate used for the preparation of the coating agent is obtained by hydrolyzing the specific siloxane compound with water.

In a method for preparing the coating agent, specifically, first, a specific siloxane compound is mixed with water to generate a hydrolyzate of the specific siloxane compound, and a hydrolyzed solution containing the specific siloxane hydrolyzate is prepared. Next, the silica particles, the high boiling point solvent, and the resin having a pyrrolidone group in a side chain are added to the obtained hydrolyzed solution.

In a case of preparing the hydrolyzed solution, in addition to the specific siloxane compound and water, a condensation catalyst and an organic solvent having a boiling point of lower than 120° C., which are the optional components described above, may be used.

The storage container for the coating agent according to the present disclosure is not particularly limited and may be a metal container, a resin container such as polyethylene or polypropylene, or a glass container.

The storage temperature of the coating agent according to the present disclosure is preferably 0° C. or higher and 50° C. or lower.

<Anti-Fogging Film>

The anti-fogging film according to the present disclosure is formed of, for example, the above-described coating agent according to the present disclosure.

In a case where the anti-fogging film is formed of the coating agent according to the present disclosure, at least some of the hydroxy groups contained in the hydrolyzate of the specific siloxane hydrolyzate are intermolecularly bonded to each other, whereby the specific siloxane hydrolyzate is condensed. Accordingly, the anti-fogging film formed of the coating agent includes a condensate of the specific siloxane hydrolyzate.

Further, as described above, the coating agent according to the present disclosure can form an anti-fogging film having a low haze.

That is, the anti-fogging film according to the present disclosure includes a condensate of the specific siloxane hydrolyzate, the silica particles, and the resin having a pyrrolidone group in a side chain, and can have a haze of 2.0% or less.

The condensate of the specific siloxane hydrolyzate included in the anti-fogging film according to the present disclosure is a condensate of the “specific siloxane hydrolyzate” described in the section of “Coating agent”.

In addition, the silica particles and the resin having a pyrrolidone group in a side chain, which are included in the anti-fogging film according to the present disclosure, are respectively the same as the “silica particles” and the “resin having pyrrolidone group in side chain” described in the section of “Coating agent”, and the preferred aspects thereof are also the same.

[Void]

Further, the anti-fogging film according to the present disclosure preferably has a void volume of 5% or more. Specifically, the anti-fogging film has the void between the silica particles in the anti-fogging film, and it is considered that the presence of the void inside the anti-fogging film exerts the anti-fogging ability.

The void volume is preferably 10% or more and 50% or less from the viewpoints of contamination resistance and the ability to suppress water drooping trace.

The void volume is a value measured using an automatic porosimeter (Autopore IV9520, manufactured by Shimadzu Corporation).

[Thickness]

The thickness of the anti-fogging film may be determined according to the use or the like and is preferably 0.1 μm or more and 30 μm or less, more preferably 0.1 μm or more and 20 μm or less, and still more preferably 0.2 μm or more and 10 μm or less.

In a case where the thickness of the anti-fogging film is in the above range, the transparency is ensured and the crack resistance is excellent.

The thickness of the anti-fogging film can be measured by an optical interference type film thickness meter, and for example, Optical Gauge series C13027 manufactured by Hamamatsu Photonics K. K. or the like is used.

[Haze]

The anti-fogging film according to the present disclosure preferably has a haze of 2.0% or less.

Specifically, the haze of the anti-fogging film is preferably as low as possible from the viewpoint of transparency, and in a case where the thickness of the anti-fogging film is in the range of 0.05 μm or more and 10 μm or less, the haze is preferably 2.0% or less, preferably 1.7% or less, preferably 1.2% or less, and still more preferably 0.5% or less.

The haze is a measured value obtained by using a haze meter (model number: NDH 5000, Nippon Denshoku Industries Co., Ltd.).

<Method for Manufacturing Anti-Fogging Film>

The method for manufacturing the anti-fogging film according to the present disclosure is not particularly limited as long as the anti-fogging film according to the present disclosure can be manufactured.

The method for manufacturing an anti-fogging film according to the present disclosure includes, for example, a step of applying the coating agent according to the present disclosure to a material to be coated (hereinafter, referred to as coating step), and a step of drying the applied coating agent (hereinafter, referred to as a drying step).

Hereinafter, the coating step and the drying step will be described.

[Coating Step]

In the coating step, the coating agent according to the present disclosure is applied to the material to be coated.

Here, the material to be coated may be a base material in a laminate, which will be described below, or may be a temporary supporting body that is peeled off from the anti-fogging film after the manufacturing of the anti-fogging film.

The coating method may be determined according to the shape and size of the material to be coated, the thickness of the coating film, and the like. For example, known coating methods such as spray coating, brush coating, roller coating, bar coating, and dip coating (so-called immersion coating) can be employed.

Among these, as the coating method, the spray coating is preferred in a case of coating a three-dimensional structure having various surface shapes such as a curved surface and a rough surface.

In a case where the coating agent is applied to the material to be coated by the spray coating, the method for setting the material to be coated is not particularly limited.

Depending on the shape of the material to be coated, the material to be coated can be coated while appropriately being changed in the orientation thereof, for example, in the horizontal or vertical direction with respect to the coating direction. In order to make the coating layer thickness more uniform, it is preferable to dispose a spray nozzle at the position where the distance between the spray nozzle and the material to be coated is equal and to coat the material to be coated. The distance between the spray nozzle and the material to be coated is preferably 10 mm or more and 1,000 mm or less.

As a method for supplying the coating agent to the coating device, any method type of a pressure-feeding type, a suction type, and a gravity type can be used.

The nozzle diameter of the spray nozzle is preferably 0.1 mmφ or more and 1.8 mmφ or less, and the air pressure is preferably 0.02 MPa or more and 0.60 MPa or less. In a case of performing coating under such conditions, the coating layer thickness can be made more uniform. In order to form a more suitable coating layer by the spray coating, it is demanded to adjust the amount of air, the amount of coating agent sprayed, the patterning aperture, and the like.

In a case where the coating agent is applied to the material to be coated by the spray coating, the air amount is preferably 5 liter (L)/minute or more and 600 L/minute or less, the amount of coating agent sprayed is preferably 5 L/minute or more and 600 L/minute or less, and the patterning aperture is preferably 40 mm or more and 450 mm or less.

In spray coating, the environment at the time of coating also affects the formation of the coating film.

The temperature condition is preferably 15° C. or higher and 35° C. or lower, and the humidity condition is preferably 80% RH or lower.

The cleanliness is not particularly limited and for example, a cleanliness of class 10,000 or higher is preferred, and a cleanliness of class 1,000 or higher is more preferred, from the viewpoint of suppressing surface failure due to fine dusts (that is, particles) in the coating environment.

The coating amount of the coating agent is not particularly limited and can be appropriately set in consideration of operability and the like depending on the concentration of the solid content in the coating agent, the desired layer thickness of the anti-fogging film, and the like.

For example, the coating amount of the coating agent is preferably 1 mL/m² or more and 400 mL/m² or less, more preferably 2 mL/m² or more and 100 mL/m² or less, still more preferably 4 mL/m² or more and 40 mL/m² or less, and particularly preferably 6 mL/m² or more 20 mL/m² or less. Within the above range, the coating accuracy is good.

[Drying Step]

In the drying step, the coating agent applied onto the material to be coated is dried.

The drying of the coating agent can be performed using a heating device.

The heating device is not particularly limited as long as it can heat the applied coating agent to a target temperature, and any known heating device can be used. As the heating device, in addition to an oven, an electric furnace, and the like, a heating device that is uniquely manufactured in accordance with the production line can be used.

The drying condition of the coating agent is not particularly limited and can be appropriately set in consideration of the curability of the coating layer.

Drying of the coating agent may be performed under constant temperature conditions in which a preset temperature is kept constant or may be performed while the temperature conditions are changed stepwise.

As the drying conditions of the coating agent in the former case, drying conditions of heating the coating agent at a surface temperature of 20° C. or higher and 150° C. or lower for 1 to 60 minutes are preferred, drying conditions of heating at a surface temperature of 40° C. or higher and 150° C. or lower for 1 minute to 60 minutes are more preferred, and drying conditions of heating at the surface temperature to 60° C. or higher and 150° C. or lower for 1 minute to 60 minutes are still more preferred.

The drying of the coating agent in the latter case is preferably carried out separately as preliminary drying and main drying. The conditions of the preliminary drying are preferably such that the surface temperature is 20° C. or higher and 60° C. or lower and heating is performed for 5 seconds to 10 minutes.

The surface temperature can be measured with an infrared thermometer or the like.

In a case where the coating agent is dried by blowing dry air, the air quantity of the dry air can be appropriately set in consideration of the optimum temperature In a case where the dry air reaches the material to be coated. However, in consideration of the drying unevenness, it is preferable to reduce the air quantity as much as possible, and it is more preferable to perform the drying in the absence of the wind, that is, under the condition that no dry air is directly applied to the material to be coated.

The material to be coated, which has been coated with the coating agent, may be placed directly on the pedestal (that is, placed flat) and dried, may be leaned and dried, or may be hung and dried, depending on the shape of the material to be coated.

As described above, the anti-fogging film is formed on the material to be coated.

<Laminate and Method for Manufacturing Laminate>

The laminate according to the present disclosure has the base material and the anti-fogging film formed on the base material by the coating agent according to the present disclosure described above.

As described above, the anti-fogging film formed of the coating agent according to the present disclosure includes a condensate of the specific siloxane hydrolyzate and has a low haze.

Accordingly, a preferred aspect of the laminate according to the present disclosure includes the base material, a condensate of the specific siloxane hydrolyzate, which is provided on the base material, the silica particles, and the resin having a pyrrolidone group in a side chain, and has an anti-fogging film having a haze of 2.0% or less.

[Base Material]

The laminate according to the present disclosure has the base material.

The material of the base material is not particularly limited and may be appropriately selected from various materials such as glass, resin (including plastic), metal, and ceramics. The material of the base material is preferably resin.

In a case where the laminate is applied to, for example, a protective material for automobile light and a protective material for a surveillance camera, it is preferable to use a resin base material.

In a case where the material of the base material is the resin, the base material is preferably an acrylic resin base material, a polycarbonate base material, or a polyethylene terephthalate base material from the viewpoint that the durability to light and heat is excellent, and a laminate excellent in adhesiveness can be formed while maintaining the transparency of the base material between the base material and the anti-fogging film, and the base material is more preferably an acrylic resin base material or a polycarbonate base material and particularly preferably a polycarbonate base material or a polymethylmethacrylate base material from the viewpoint that a laminate having an excellent adhesiveness can be formed.

Further, as the material of the base material, a composite material formed of a plurality of materials can also be used. For example, the material of the base material may be a composite material including glass and a resin material, in which the glass and the resin material are mixed and composited, a resin composite material in which a plurality of kinds of resin materials are kneaded or pasted, or the like.

The thickness and the shape of the base material are not particularly limited and are appropriately set according to the application target.

Further, the surface of the base material may be subjected to a surface treatment, as necessary. The surface treatment method is not particularly limited and a known method can be used.

[Anti-Fogging Film]

The laminate according to the present disclosure has the anti-fogging film.

The anti-fogging film may be provided on a part of the base material or may be provided on the entire surface of the base material. In addition, the anti-fogging film may be in direct contact with the base material or may not be in direct contact with the base material.

The anti-fogging film in the laminate according to the present disclosure is the same as the anti-fogging film according to the present disclosure, and the preferred aspect thereof is also the same.

[Use of Laminate]

The laminate according to the present disclosure can be used for various uses.

Specifically, the laminate can be suitably used to add functions such as anti-fogging property for, for example: protective materials (so-called protective cover) for protecting a surveillance camera, lighting equipment, and sensor lighting appliance; roofing materials for garages of vehicles such as an automobile and a motorcycle; signs such as road signs; sound barriers for installations for the shoulder of highway roads, railways, and the like; bodies of vehicles such as an automobile and a motorcycle; protective materials for an automobile (for example, lenses), for window glass, a mirror, and a light; tools for eye protection such as goggles and safety glasses; a shield material for a helmet; and an internal lens for a head mounted display.

Among these, the laminate according to the present disclosure can be more suitably used as a protective material for automobile lights (a headlight, a tail lamp, a door mirror winker light, and the like) and a protective material for a surveillance camera.

Generally, an automobile is constituted to have a light unit and a lens for protecting the light. In transparent base materials such as glass and plastic, which are used in the light unit, moisture in the atmosphere adheres to the base material as water droplets, and the resultant dews are condensed on the base material surface, in a case where one surface of the inner surface and the outer surface has a temperature of a dew point or less due to the difference in temperature and humidity between the inner surface and the outer surface across the base material, or in a case where the temperature and the humidity suddenly change with respect to the base material (for example, in a case where boiling steam comes into contact the base material or the base material is moved from a low temperature environment to a hot and humid environment). As a result, the so-called “fogging”, a phenomenon in which light is scattered by the condensed water droplets, may occur. In a case where such “fogging” occurs in the headlight, the rear light, or the like, the appearance is significantly impaired. Such fogging also occurs in a protective cover of a surveillance camera having the protective cover (that is, a surveillance camera integrated with a housing), which significantly impairs visibility and safety. The appearance, the function, and the performance of the automobile light and the surveillance camera are not impaired since the laminate according to the present disclosure has low haze and excellent transparency, and the anti-fogging property can be maintained for a long time since the laminate according to the present disclosure is excellent in anti-fogging property and contamination resistance.

[Method for Manufacturing Laminate]

The method for manufacturing the laminate according to the present disclosure is not particularly limited as long as the laminate according to the present disclosure can be manufactured.

The method for manufacturing the laminate according to the present disclosure includes, for example, a step of applying the coating agent according to the present disclosure to a base material (hereinafter, referred to as coating step), and a step of drying the applied coating agent (hereinafter, referred to as a drying step).

The coating step and the drying step in the method for manufacturing the laminate are the same as the coating step and the drying step in the method for manufacturing the anti-fogging film according to the present disclosure, and the preferred aspects are also the same.

### EXAMPLES

Hereinafter, the embodiments of the present invention will be specifically described with reference to Examples, but the present invention is not limited to the following Examples unless the gist of the present invention is exceeded. In addition, in present Examples, “%” means “% by mass” unless otherwise specified.

### Example 1

<Preparation of Hydrolyzed Solution>

The following components were mixed to obtain a mixture.
Ethanol (a solvent other than high boiling point solvent, abbreviated as EtOH): 52 parts by mass
MKC (registered trademark) silicate MS51 (a specific siloxane compound, abbreviated as MS51): 48 parts by mass

To the above mixture, 100 parts by mass of ion exchange water (a solvent other than the high boiling point solvent) were gradually added, and finally, 6 parts by mass of acetic acid (100%) were added, and the mixture was stirred for 24 hours or more at room temperature (25° C., the same hereinafter).

The specific siloxane compound was hydrolyzed in the obtained mixture, whereby a hydrolyzed solution containing the specific siloxane hydrolyzate was obtained.

<Preparation of Coating Agent>

A coating agent was prepared by mixing the following components. The obtained coating agent was used as a coating agent 1 of Example 1.
hydrolyzed solution described above (solid content of specific siloxane hydrolyzate: 24%): 100 parts by mass
SNOWTEX (registered trademark) OXS (silica particles, abbreviated as ST-OXS): 440 parts by mass
PVP/VAS-630 (a copolymer of vinylpyrrolidone and vinyl acetate, a resin having a pyrrolidone group in a side chain, abbreviated as S-630): 26 parts by mass
Aluminum chelate D (an aluminum chelate compound, abbreviated as AL-D): 6 parts by mass
Ion exchange water (a solvent other than high boiling point solvent): 370 parts by mass
Ethanol (a solvent other than high boiling point solvent, abbreviated as EtOH): 814 parts by mass
Propylene glycol monomethyl ether (a high boiling point solvent, abbreviated as MFG): 744 parts by mass

—Formation of Anti-Fogging Film and Manufacturing of Laminate—

One surface of a polycarbonate base material (AGC Inc., CARBOGLASS C-110, thickness: 0.5 mm), which is a base material, was coated with the obtained coating agent 1 by using a spray gun (W-101-101G, manufactured by Anest Iwata Corporation), allowed to be left at 30° C. for 1 minute, and then dried at 120° C. for 20 minutes to form an anti-fogging film having a dried film thickness of 300 nm, provided on the base material.

In this manner, a laminate having an anti-fogging film formed on the base material was obtained.

### Examples 2 to 25 and Comparative Examples 1 to 4

Coating agents 2 to 25 of Examples 2 to 25 and coating agents C1 to C4 of Comparative Examples 1 to 4 were obtained in the same manner as in Example 1, except that the preparations of hydrolyzed solutions and the preparations of coating agents were performed by properly changing the components used, the types of the components, and the amount used so that the configurations of the solid contents, the compositions of the solvents, and the concentrations of the solid contents, which are shown in Tables 2 to 4 below, were obtained.

In Tables 2 to 4 below, the configuration of the solid content and the composition of the solvent are respectively 100% by mass in total. The concentration of solid content is a percentage of the total amount of the solid content in the coating agent.

The condensation catalysts shown in Tables 2 to 4 below were used at the time of preparing the coating agent. Further, in a case of using a plurality of kinds of high boiling point solvents, all the high boiling point solvents were used at the time of preparing the coating agent.

In Comparative Example 1, a coating agent was prepared using polyvinyl alcohol instead of the resin having a pyrrolidone group in a side chain. In Table 4, the pyrrolidone group is indicated by “(PVA*)” in the column of “Resin having pyrrolidone group in side chain”.

In Comparative Example 4, a coating agent was prepared using n-butyl alcohol instead of the high boiling point solvent. In Table 4, the high boiling point solvent is indicated by“(nBA*)” in the column of “High boiling point solvent”.

Next, laminates of Examples 2 to 25 and Comparative Examples 1 to 4 were obtained by forming anti-fogging films on the polycarbonate base material in the same manner as in Example 1 except that the coating agent 1 was replaced with the respective coating agents 2 to 25 and C1 to C4.

TABLE 2

| | | Configuration of solid content (% by mass) | | | | | | | | | | | | | |
|---|---|---|---|---|---|---|---|---|---|---|---|---|---|---|---|
| | | | | | | Resin having | | | | Composition of Solvent (% by mass) | | | | | |
| | Coating | Specific | | | | pyrrolidone | | | | | | | | Solvent other than | |
| | agent | siloxane | | Silica | | group in side | | Condensation | | | | | | high boiling point | |
| | No. | compound | | particle | | chain | | catalyst | | High boiling point solvent | | | | solvent | |
| Example 1 | 1 | MS51 | 24 | ST-OXS | 44 | S630 | 26 | AL-D | 6 | MFG | 31 | — | — | EtOH | 35 |
| Example 2 | 2 | MS51 | 24 | ST-O33 | 44 | S630 | 26 | AL-D | 6 | MFG | 31 | — | — | EtOH | 35 |
| Example 3 | 3 | MS51 | 24 | ST-OUP | 44 | S630 | 26 | AL-D | 6 | MFG | 31 | — | — | EtOH | 35 |
| Example 4 | 4 | MS51 | 24 | ST-O33 | 50 | S630 | 20 | AL-D | 6 | MFG | 31 | — | — | EtOH | 35 |
| Example 5 | 5 | MS51 | 24 | ST-O33 | 50 | K30 | 20 | AL-D | 6 | MFG | 31 | — | — | EtOH | 35 |
| Example 6 | 6 | MS51 | 24 | ST-O33 | 50 | E735 | 20 | AL-D | 6 | MFG | 31 | — | — | EtOH | 35 |
| Example 7 | 7 | MS51 | 24 | ST-O33 | 50 | S630 | 20 | AL-D | 6 | MMGAC | 31 | — | — | EtOH | 35 |
| Example 8 | 8 | MS51 | 24 | ST-O33 | 50 | S630 | 20 | AL-D | 6 | ETB | 31 | — | — | EtOH | 35 |
| Example 9 | 9 | MS51 | 24 | ST-O33 | 50 | S630 | 20 | AL-D | 6 | EL | 31 | — | — | EtOH | 35 |
| Example 10 | 10 | MS51 | 24 | ST-O33 | 50 | S630 | 20 | AL-D | 6 | PNP | 31 | — | — | EtOH | 35 |
| Example 11 | 11 | MS51 | 24 | ST-O33 | 50 | S630 | 20 | AL-D | 6 | ETB | 31 | — | — | EtOH | 69 |

| | Composition of Solvent (% by mass) | | Concentration | | Initial | | |
|---|---|---|---|---|---|---|---|
| | Solvent other than | | of solid | | anti- | | Water |
| | high boiling point | | content | Haze | fogging | Contamination | drooping |
| | solvent | | (% by mass) | (%) | property | resistance | trace |
| Example 1 | Water | 34 | 4 | 1.0 | 3 | 3 | 3 |
| Example 2 | Water | 34 | 4 | 1.4 | 4 | 4 | 3 |
| Example 3 | Water | 34 | 4 | 1.6 | 3 | 3 | 3 |
| Example 4 | Water | 34 | 4 | 1.5 | 4 | 4 | 3 |
| Example 5 | Water | 34 | 4 | 1.9 | 4 | 3 | 3 |
| Example 6 | Water | 34 | 4 | 1.5 | 4 | 4 | 3 |
| Example 7 | Water | 34 | 4 | 0.6 | 5 | 4 | 3 |
| Example 8 | Water | 34 | 4 | 0.3 | 5 | 5 | 3 |
| Example 9 | Water | 34 | 4 | 0.4 | 4 | 4 | 3 |
| Example 10 | Water | 34 | 4 | 0.4 | 4 | 4 | 3 |
| Example 11 | — | — | 4 | 1.5 | 5 | 4 | 3 |

TABLE 3

| | | Configmation of solid content (% by mass) | | | | | | | | | | | | | |
|---|---|---|---|---|---|---|---|---|---|---|---|---|---|---|---|
| | | | | | | Resin having | | | | Composition of Solvent (% by mass) | | | | | |
| | Coating | Specific | | | | pyrrolidone | | | | | | | | Solvent other than | |
| | agent | siloxane | | | | group in side | | Condensation | | | | | | high boiling point | |
| | No. | compound | | Silica particle | | chain | | catalyst | | High boiling point solvent | | | | solvent | |
| Example 12 | 12 | MS51 | 24 | ST-O33 | 50 | S630 | 20 | AL-D | 6 | ETB | 14 | DPM | 10 | EtOH | 66 |
| Example 13 | 13 | MS51 | 24 | ST-O33 | 50 | S630 | 20 | AL-D | 6 | ETB | 14 | DPM | 8 | EtOH | 68 |
| Example 14 | 14 | MS51 | 24 | ST-O33 | 50 | S630 | 20 | AL-D | 6 | ETB | 14 | DPM | 6 | EtOH | 70 |
| Example 15 | 15 | MS51 | 24 | ST-O33 | 50 | S630 | 20 | AL-D | 6 | ETB | 14 | DM | 6 | EtOH | 70 |
| Example 16 | 16 | MS51 | 24 | ST-O33 | 50 | S630 | 20 | AL-D | 6 | ETB | 14 | DM | 4 | EtOH | 72 |
| Example 17 | 17 | MS51 | 24 | ST-O33 | 50 | S630 | 20 | AL-D | 6 | ETB | 14 | DM | 2 | EtOH | 74 |
| Example 18 | 18 | TEOS | 24 | ST-O33 | 50 | S630 | 20 | AL-D | 6 | ETB | 14 | DPM | 8 | EtOH | 68 |
| Example 19 | 19 | MS51 | 24 | ST-O33 | 50 | K30 | 20 | AL-D | 6 | ETB | 14 | DPM | 8 | EtOH | 68 |
| Example 20 | 20 | MS51 | 24 | ST-O33 | 50 | E735 | 20 | AL-D | 6 | ETB | 14 | DPM | 8 | EtOH | 68 |
| Example 21 | 21 | MS51 | 24 | ST-O33 | 50 | S630 | 20 | AL-D | 6 | ETB | 14 | DPM | 8 | EtOH | 68 |
| Example 22 | 22 | MS51 | 24 | ST-O33 | 50 | S630 | 20 | AL-D | 6 | ETB | 14 | DPM | 8 | EtOH | 68 |
| Example 23 | 23 | MS51 | 24 | ST-O33 | 50 | S630 | 20 | AL-D | 6 | ETB | 14 | DPM | 8 | EtOH | 68 |
| Example 24 | 24 | MS51 | 24 | ST-O33 | 50 | S630 | 20 | — | — | ETB | 14 | DPM | 10 | EtOH | 66 |
| Example 25 | 25 | MS51 | 24 | ST-O33 | 50 | S630 | 20 | AL-D | 6 | ETB | 14 | DAA | 10 | EtOH | 66 |

| | Composition of Solvent (% by mass) | | Concentration | | Initial | | |
|---|---|---|---|---|---|---|---|
| | Solvent other than | | of solid | | anti- | | Water |
| | high boiling point | | content | Haze | fogging | Contamination | drooping |
| | solvent | | (% by mass) | (%) | property | resistance | trace |
| Example 12 | Water | 10 | 4 | 0.4 | 5 | 5 | 3 |
| Example 13 | Water | 10 | 4 | 0.4 | 5 | 5 | 3 |
| Example 14 | Water | 10 | 4 | 0.4 | 5 | 5 | 3 |
| Example 15 | Water | 10 | 4 | 0.4 | 5 | 5 | 3 |
| Example 16 | Water | 10 | 4 | 0.4 | 5 | 5 | 3 |
| Example 17 | Water | 10 | 4 | 0.4 | 5 | 5 | 3 |
| Example 18 | Water | 10 | 4 | 0.4 | 5 | 5 | 3 |
| Example 19 | Water | 10 | 4 | 0.4 | 5 | 5 | 3 |
| Example 20 | Water | 10 | 4 | 1.0 | 5 | 4 | 3 |
| Example 21 | Water | 10 | 6 | 0.4 | 5 | 5 | 3 |
| Example 22 | Water | 10 | 8 | 0.4 | 5 | 5 | 3 |
| Example 23 | Water | 10 | 10 | 0.4 | 5 | 5 | 3 |
| Example 24 | Water | 10 | 4 | 0.8 | 4 | 5 | 3 |
| Example 25 | Water | 10 | 4 | 0.4 | 5 | 5 | 3 |

TABLE 4

| | | Configmation of solid content (% by mass) | | | | | | | | | | | | | |
|---|---|---|---|---|---|---|---|---|---|---|---|---|---|---|---|
| | | | | | | Resin having | | | | Composition of Solvent (% by mass) | | | | | |
| | Coating | Specific | | | | pyrrolidone | | | | | | | | Solvent other than | |
| | agent | siloxane | | Silica | | group in side | | Condensation | | | | | | high boiling point | |
| | No. | compound | | particle | | chain | | catalyst | | High boiling point solvent | | | | solvent | |
| Comparative | C1 | MS51 | 24 | ST-O33 | 50 | (PVA*) | 20 | AL-D | 6 | ETB | 14 | DPM | 10 | EtOH | 66 |
| Example 1 | | | | | | | | | | | | | | | |
| Comparative | C2 | — | — | ST-O33 | 60 | S630 | 30 | AL-D | 10 | ETB | 14 | DPM | 10 | EtOH | 80 |
| Example 2 | | | | | | | | | | | | | | | |
| Comparative | C3 | MS51 | 24 | ST-O33 | 50 | S630 | 20 | AL-D | 6 | — | — | — | — | EtOH | 50 |
| Example 3 | | | | | | | | | | | | | | | |
| Comparative | C4 | MS51 | 24 | ST-O33 | 50 | S630 | 20 | AL-D | 6 | (nBA*) | 24 | | | EtOH | 66 |
| Example 4 | | | | | | | | | | | | | | | |

| | Composition of Solvent (% by mass) | | Concentration | | Initial | | |
|---|---|---|---|---|---|---|---|
| | Solvent other than | | of solid | | anti- | | Water |
| | high boiling point | | content | Haze | fogging | Contamination | drooping |
| | solvent | | (% by mass) | (%) | property | resistance | trace |
| Comparative | Water | 10 | 4 | 2.1 | 3 | 1 | 3 |
| Example 1 | | | | | | | |
| Comparative | Water | 20 | 4 | 2.3 | 2 | 2 | 1 |
| Example 2 | | | | | | | |
| Comparative | Water | 50 | 4 | 2.5 | 3 | 1 | 3 |
| Example 3 | | | | | | | |
| Comparative | Water | 10 | 4 | 2.1 | 3 | 2 | 3 |
| Example 4 | | | | | | | |

The details of each component shown in Tables 2 to 4 used in each Example and Comparative Example are described below.

—Specific Siloxane Compound—
MS51: MKC (registered trademark) silicate MS51 (R¹, R², R³, and R⁴ in General Formula (1): methyl group, average of n: 5, manufactured by Mitsubishi Chemical Corporation)
TEOS: Tetraethoxysilane (manufactured by Tokyo Chemical Industry Co., Ltd.)

—Silica Particles—
ST-OXS: SNOWTEX (registered trademark) OXS (an aqueous dispersion of silica particles, solid content: 10%, average primary particle diameter: 4 nm to 6 nm, manufactured by Nissan Chemical Corporation)
ST-033: SNOWTEX (registered trademark) 033 (an aqueous dispersion of silica particles, solid content: 15%, average primary particle diameter: 10 nm to 15 nm, manufactured by Nissan Chemical Corporation)
ST-OUP: SNOWTEX (registered trademark) OUP (an aqueous dispersion of silica particles, solid content: 15%, average primary particle diameter: 40 nm to 100 nm, manufactured by Nissan Chemical Corporation)

—Resin Having a Pyrrolidone Group in Side Chain—
S630: PVP/VAS-630 (a copolymer of 60% by mass of a constitutional unit derived from vinylpyrrolidone and 40% by mass of a constitutional unit derived from vinyl acetate, weight-average molecular weight: 51,000, solid content: 100% by mass)
E-735: PVP/VAE-735 (a copolymer of 70% by mass of a constitutional unit derived from vinylpyrrolidone and 30% by mass of a constitutional unit derived from vinyl acetate, weight-average molecular weight: 56,700, a solution of 50% by mass of ethanol)
K30: Pitskol (registered trademark) K-30 (a vinylpyrrolidone homopolymer, solid content: 100%, weight-average molecular weight: 45,000, manufactured by Dai-ichi Kogyo Seiyaku Co., Ltd.)

—Resin Used in Comparative Example 1—
PVA: polyvinyl alcohol (weight-average molecular weight: 20,000, manufactured by Tokyo Chemical Industry Co., Ltd.)

—Condensation Catalyst—
AL-D: aluminum chelate D (an aluminum chelate compound, a 76% aqueous solution, manufactured by Kawaken Fine Chemicals Co., Ltd.)

—High Boiling Point Solvent—
MFG: propylene glycol monomethyl ether (boiling point: 121° C., manufactured by Tokyo Chemical Industry Co., Ltd.)
MMGAC: ethylene glycol monomethyl ether acetate (boiling point: 145° C., manufactured by Tokyo Chemical Industry Co., Ltd.)
ETB: ethylene glycol mono-tert-butyl ether (boiling point: 153° C., manufactured by Tokyo Chemical Industry Co., Ltd.)
EL: ethyl acetate (boiling point: 154° C., manufactured by Tokyo Chemical Industry Co., Ltd.)
PNP: propylene glycol monopropyl ether (boiling point: 150° C., manufactured by Tokyo Chemical Industry Co., Ltd.)
DAA: diacetone alcohol (boiling point: 169° C., manufactured by Tokyo Chemical Industry Co., Ltd.)
DM: diethylene glycol monomethyl ether (boiling point: 194° C., manufactured by Tokyo Chemical Industry Co., Ltd.)
DPM: dipropylene glycol monomethyl ether (boiling point: 188° C., manufactured by Tokyo Chemical Industry Co., Ltd.)

—Solvent Other than High Boiling Point Solvent—
EtOH: ethanol (boiling point: 78° C., manufactured by Tokyo Chemical Industry Co., Ltd.)
nBA: n-butyl alcohol (boiling point: 118° C., manufactured by Tokyo Chemical Industry Co., Ltd.)
Water: ion exchange water (boiling point: 100° C.)

—Evaluation—

The following measurement or evaluation was performed using the manufactured laminate.

The evaluation results are shown in Tables 2 to 4.

(1) Measurement of Haze

The haze of the manufactured laminate was measured using a haze meter (model number: NDH 5000, Nippon Denshoku Industries Co., Ltd.).

The haze was measured by directing the light source toward the anti-fogging film side. It is evaluated that the smaller the haze value of the laminate is, the better the transparency of the laminate is. The haze is preferably 2.0% or less.

In a case where the haze of the laminate is 2.0% or less, it can be said that the haze of the anti-fogging film itself is 2.0% or less.

(2) Evaluation of Initial Anti-Fogging Property

Steam generated from water heated to 60° C. was applied to the anti-fogging film of the manufactured laminate for 20 seconds at a distance of 20 mm from the water surface, and then the degree of fogging of the anti-fogging film was visually evaluated.

The evaluation criteria are as follows. 3 to 5 is the allowable range.

—Evaluation Indices—

5: Fogging is not observed at all, and a clear water film is formed.

4: Fogging is not observed, a water film is formed, and the formed water film waves slightly.

3: Fogging is not observed, a water film is formed, and the formed water film waves.

2: A water film is formed non-uniformly.

1: Fogging is observed, and a water film is not formed.

(3) Evaluation of Contamination Resistance

Steam generated by heating silicone oil (TSF458-100, manufactured by Momentive Performance Materials Inc.) to 80° C. on a hot plate was applied to the anti-fogging film of the manufactured laminate for 24 hours. Thereafter, steam generated from water heated to 60° C. was applied to the anti-fogging film for one minute at a distance of 20 mm from the water surface, and then the degree of fogging of the anti-fogging film was visually evaluated.

The evaluation criteria are as follows. 3 to 5 is the allowable range.

—Evaluation Indices—

5: Fogging is not observed at all, and a clear water film is formed.

4: Fogging is not observed, a water film is formed, and the formed water film waves slightly.

3: Fogging is not observed, a water film is formed, and the formed water film waves.

2: A water film is formed non-uniformly.

1: Fogging is observed, and a water film is not formed.

(4) Evaluation of Water Drooping Trace

The manufactured laminate was cut into a size of 10 cm×10 cm to obtain an evaluation sample.

After 10 ml of water was sprayed onto the anti-fogging film of the evaluation sample to form a water film on the surface of the anti-fogging film, the evaluation sample was allowed to be left in a state of being vertically leaned to dry the water film.

After all the water on the surface of the anti-fogging film was dried, the surface of the anti-fogging film was visually observed, and the presence or absence of the trace of water drooping was observed and evaluated.

The evaluation criteria are as follows. 3 is the allowable range.

—Evaluation Indices—

3: Trace of water drooping is not observed.

2: Trace of water drooping is observed slightly.

1: Trace of water drooping is observed clearly.

As shown in Tables 2 to 4, it can be seen that in the case of the coating agents obtained Examples, anti-fogging films having a low haze, an excellent initial anti-fogging property, and an excellent contamination resistance (that is, anti-fogging property after being exposed to contaminants) as compared with the coating agents obtained in Comparative Examples can be obtained. Further, it can be seen that in the case of the coating agents obtained in Examples, anti-fogging films in which the trace of water drooping is not observed is formed, and thus the evaluation of water drooping trace is also good.

From the comparison of Examples 1 to 3, it can be seen that in a case where the average primary particle diameter of the silica particles is in the range of 10 nm to 20 nm, the initial anti-fogging property and the contamination resistance are enhanced. This is presumably because the void size formed between the silica particles in the anti-fogging film is optimized in a case where the particle diameter of the silica particles is within the above range.

From the comparison of Examples 2 and Example 4, it can be seen that in a case where the content of the silica particles in the coating agent is 45% by mass or more, the initial anti-fogging property and the contamination resistance are enhanced. This is presumably because the volume of the void formed between the silica particles in the anti-fogging film is optimized in a case where the content of the silica particles is within the above range.

From the comparison of Example 4, Example 7, and Example 8, it can be seen that in a case where the high boiling point solvent having a high boiling point is used, the film forming property is enhanced, and as a result, an anti-fogging film having a low haze and excellent in the initial anti-fogging property is obtained.

From the comparison of Example 4, Example 9, and Example 10, it can be seen that the high boiling point solvent is preferably a glycol ether-based solvent, and a solvent having a branched alkyl group is preferred.

From the comparison of Example 8 and Example 11, it can be seen that in a case of including water, the haze and the contamination resistance are excellent. This is presumably because the dispersibility of the silica particles is improved in a case where the coating agent includes water.

What is claimed is:

1. A coating agent comprising:
a hydrolyzate of a compound represented by General Formula (1);
silica particles;
a high boiling point solvent having a boiling point of 120° C. or higher; and
a resin having a pyrrolidone group in a side chain, 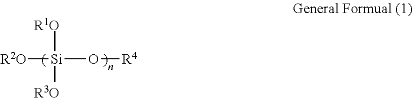
in General Formula (1), R¹, R², R³, and R⁴ each independently represent a monovalent organic group having 1 to 6 carbon atoms, and n represents an integer of 1 to 20.

2. The coating agent according to claim 1, further comprising:
a metal chelate compound as a condensation catalyst.

3. The coating agent according to claim 1, wherein the resin having a pyrrolidone group in a side chain is a resin containing a constitutional unit derived from vinylpyrrolidone.

4. The coating agent according to claim 1, wherein the resin having a pyrrolidone group in a side chain is a resin containing a constitutional unit derived from vinylpyrrolidone and a constitutional unit derived from a monomer having a C log P value of 0.7 to 3.0.

5. The coating agent according to claim 4, wherein the constitutional unit derived from the monomer having a C log P value of 0.7 to 3.0 is a constitutional unit derived from vinyl acetate.

6. The coating agent according to claim 1, wherein a content of the resin having a pyrrolidone group in a side chain is 30% by mass to 60% by mass with respect to a mass of the silica particles contained in the coating agent.

7. The coating agent according to claim 1, wherein an average primary particle diameter of the silica particles is 10 nm to 20 nm.

8. The coating agent according to claim 1, wherein a content of the silica particles with respect to a total solid content is 45% by mass or more.

9. The coating agent according to claim 1, wherein the high boiling point solvent has a boiling point of 140° C. or higher.

10. The coating agent according to claim 9, wherein the high boiling point solvent has a boiling point of 150° C. or higher.

11. The coating agent according to claim 1, wherein the high boiling point solvent is a glycol ether-based solvent.

12. The coating agent according to claim 1, wherein the high boiling point solvent is a solvent having a branched alkyl group.

13. The coating agent according to claim 1, further comprising:
water.

14. The coating agent according to claim 1, wherein a content of the high boiling point solvent is 10% by mass to 50% by mass with respect to a total mass of all solvents contained in the coating agent.

15. An anti-fogging film formed of the coating agent according to claim 1.

16. An anti-fogging film comprising:
a hydrolyzate of a compound represented by General Formula (1);
silica particles; and
a resin having a pyrrolidone group in a side chain,
wherein the anti-fogging film has a haze of 2.0 or less, 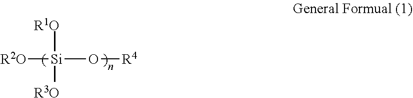
in General Formula (1), R¹, R², R³, and R⁴ each independently represent a monovalent organic group having 1 to 6 carbon atoms, and n represents an integer of 1 to 20.

17. A method for manufacturing an anti-fogging film comprising:
applying the coating agent according to claim 1 to a material to be coated; and
drying the applied coating agent.

18. A laminate comprising:
a base material; and
an anti-fogging film formed of the coating agent according to claim 1, which is provided on the base material.

19. A laminate comprising:
a base material; and
an anti-fogging film having a haze of 2.0 or less, which is provided on the base material,
wherein the anti-fogging film includes a hydrolyzate of a compound represented by General Formula (1), silica particles, and a resin having a pyrrolidone group in a side chain, 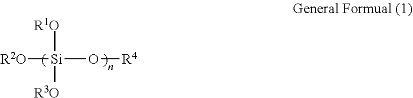
in General Formula (1), R¹, R², R³, and R⁴ each independently represent a monovalent organic group having 1 to 6 carbon atoms, and n represents an integer of 1 to 20.

20. The laminate according to claim 18, wherein the base material is a polycarbonate base material or a polymethylmethacrylate base material.
